(19) United States
(12) Patent Application Publication
(10) Pub. No.: US 2011/0315477 A1
(43) Pub. Date: Dec. 29, 2011

(54) ELECTROADHESION DEVICE FOR IMPROVING EXTENSION LADDER STABILITY

(75) Inventors: Harsha Prahlad, Cupertino, CA (US); Ronald E. Pelrine, Longmont, CO (US); Peter Simeonov, Morgantown, WV (US); Hongwei Hsiao, Morgantown, WV (US)

(73) Assignees: The Government of the United States of America as represented by the Secretary of the; SRI International, Menlo Park, CA (US); Department of Health and Human Services, Centers for Disease Control and Prevention

(21) Appl. No.: 12/972,308

(22) Filed: Dec. 17, 2010

Related U.S. Application Data
(60) Provisional application No. 61/288,231, filed on Dec. 18, 2009.

(51) Int. Cl. E06C 7/46

(52) U.S. Cl. 182/108

(57) ABSTRACT

A method of stabilizing a ladder is provided by attaching one or more electroadhesive devices to an attachment point on the ladder and contacting the device to a surface such as a wall or the floor. The electrostatic force achieved by applying a voltage difference in the device provides decreased ladder slip angles or increased shear forces required to create ladder slippage thereby improving ladder stability.

### CROSS-REFERENCE TO RELATED APPLICATIONS

This application claims priority to U.S. Provisional Application No. 61/288,231 filed Dec. 18, 2009, the entire contents of which are incorporated herein by reference.

### FIELD OF THE INVENTION

The invention relates to methods of increasing personal safety in both home and work environments. Systems are used to increase ladder stability thereby reducing the likelihood of falls. An inventive method employs electroadhesion devices to various ladder contact points thereby reducing ladder slip angle and improving ladder stability.

### BACKGROUND OF THE INVENTION

The leading cause of unintentional non-fatal injuries in the United States is due to falls. (Office of Statistics and Programming, National Center for Injury Prevention and Control. 10 leading causes of nonfatal injury by age group, United States—2007) A chief component of falls from heights is falls from a ladder either in a work or home environment. Males aged 35 to 55 years of age are at the highest risk of injury. This high injury risk is acutely prevalent in the non-occupational environment accounting for ½ to ⅔ of injuries from ladder related falls. Despite the high risk, the public receives little to no common ladder related safety instruction.

The most common injury types are strains/sprains, bruises/contusions, and fractures to the extremities. (D'Souza, A, et al., American Journal of Preventive Medicine, 2007; 32:413-418) A recent meta-analysis of injury data obtained over a 15 year period revealed an average of 136,118 ladder related injuries in the United States annually with an average of 49.5 cases per 10,000 people. Id. Most striking was the authors' recognition of an increase in ladder related injuries of 50% between the years 1990 and 2005 indicating that ladder safety is not being properly addressed by current societal practices. These injuries lead to an appreciable decrease in work productivity due to injury related time absent from work, as well as high costs associated with medical and workman's compensation claims.

Extension ladders are inherently unstable structures, and ladder stability failure is a major cause for ladder fall injury. Insufficient friction at ladder legs combined with sub-optimal positioning angle is a common precursor of ladder fall incidents. Thus, there is a need for a method of increasing ladder safety as a means of reducing falls and ladder related injuries in both the home and work environments.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

A method of decreasing ladder slip angle is provided including attaching at least one, optionally a plurality of, electroadhesive device(s) to a contact point on a ladder, contacting the device with a substrate such that the ladder forms a non-normal positional angle between a horizontal surface and the ladder length, and generating a first voltage difference between two electrodes within the device that increases the shear force required to slide the contact point along the substrate thereby decreasing the ladder slip angle for ladder stability.

Multiple devices are optionally attached to a ladder and contacted with a substrate. In some embodiments, at least one of the devices is optionally contacted to a vertical substrate and at least one of said devices in contacted to a horizontal substrate. Each device optionally includes a plurality of electroadhesive surfaces wherein each of the surfaces includes two electrodes with a voltage difference therebetween. Optionally, each electroadhesive surface includes one electrode with a voltage difference to a single opposing electrode common to all the adhesive surfaces. Each of the plurality of electroadhesive surfaces is optionally adhered to the substrate at a non-zero angle relative to at least one other adhesive surface.

The substrate in the inventive method is optionally parallel to the vertical or horizontal direction and may be curvilinear or any other shape. A device optionally conforms to the shape of the substrate that it contacts.

The shear force required to slide the contact point is increased by the inventive method to between 1 and 50 kilograms, optionally, equal to or in excess of 20 kilograms.

An inventive method also may include removing the first voltage difference, altering the positional angle or moving the ladder, and creating a second voltage difference between the two electrodes. The second voltage difference is optionally equal to, greater than, or less than, the first voltage difference, such that the adhesive force applied by a device to a substrate during the second voltage difference may be equal to, greater than, or less than, respectively, the adhesive force applied during a first voltage difference.

### BRIEF DESCRIPTION OF THE DRAWINGS

FIG. 1 illustrates the forces observed on a ladder when placed at an angle to a substrate;

FIG. 2 illustrates the required coefficient of friction (RCOF) at a ladder base as a function of ladder angle and clamping force for an EA pad positioned at the floor;

FIG. 3 illustrates a device attached to a ladder at a top end of the side rails and a second device attached at the bottom end of the side rails;

FIG. 4 illustrates measured lateral pressure values using an electroadhesive device with an area of 4 ft² against typical wall or floor materials;

FIG. 5 illustrates an embodiment including a plurality of adhesive surfaces attached to a single attachment point on a ladder;

FIG. 6 illustrates calculated ladder slip angles (A) and gain in ladder slip angle (B) using experimental force values as well as ladder slip angles at various user weights (C);

FIG. 7 illustrates attaching a device to the top of a ladder;

FIG. 8 illustrates attaching a device to the bottom of a ladder;

FIG. 9 depicts experimentally determined ladder slip angles on various surfaces using a device contacting a floor.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only.

The invention has utility as method of improving ladder stability. Inventive methods provide increased adhesion between a ladder contact point and a substrate. This increased adhesion prevents ladder slippage either in a vertical or horizontal direction such that the ladder is more forgiving of improper use, user stretching, or aberrant movements.

A method of decreasing a ladder slip angle is provided. As used herein, the term “ladder slip angle” refers to the greatest angle between a ladder length and a horizontal whereby a ladder contact point will overcome frictional force and slide against a substrate it is in contact with. A smaller ladder slip angle is achieved by increasing the shear force required to cause a contact point of a ladder to slide along a substrate. With the higher required shear force a ladder can be positioned at a more extreme (smaller) positional angle relative to the horizontal prior to slippage at one or more contact points. Also, as the shear force required to cause slippage at a contact point is independent of direction along the plane of the substrate, the reduced chance of ladder slippage horizontally as well as vertically is achieved. A ladder slip angle is related to a required coefficient of friction (RCOF). It is appreciated that with a constant coefficient of static friction at a ladder base, the ladder will slip at a certain positional angle. Yet with application of an electro-adhesion device, ladder slip angle will be reduced. If positional angle of the ladder is held constant, then application of an electroadhesion device will reduce the RCOF required to hold the ladder positional angle.

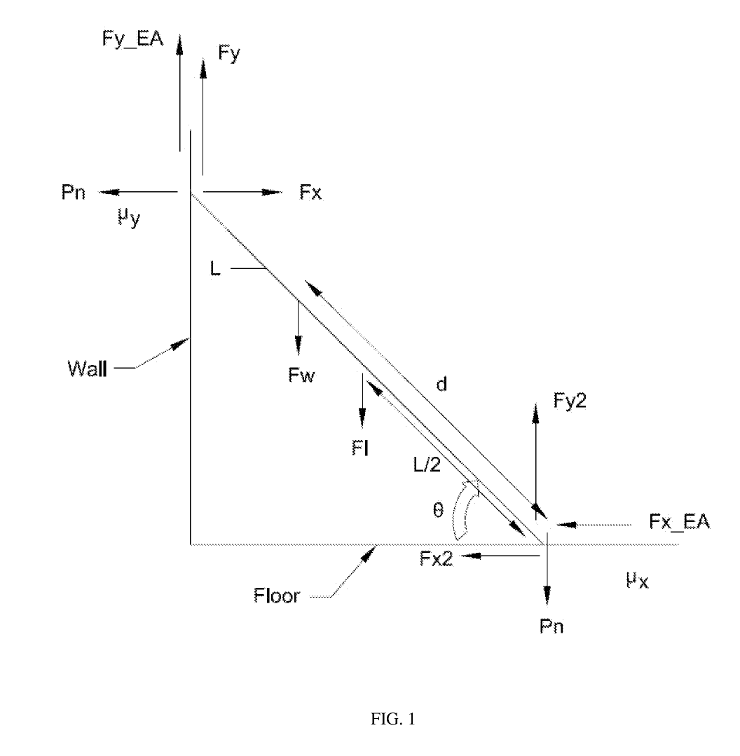

A ladder slip angle is determined by taking into account several parameters related to ladder positioning. FIG. 1 illustrates the various forces at work in maintaining constant ladder positioning. As used in the equations that follow: the term μ_{y} is the coefficient of static friction against a vertical substrate; μₓ is the coefficient of static friction against a horizontal substrate; the term Fy_EA is the shear resistive force applied by an electroadhesive device positioned at the end of a ladder in contact with a vertical substrate; Fx_EA is the shear resistive force applied by an electroadhesive device in contact with a horizontal substrate; Fy is the vertical reaction force; Fy2 is the vertical reaction force normal to a horizontal substrate; Fx is the horizontal reaction force normal to a vertical substrate; Fx2 is the horizontal reaction force; L is a ladder length; Fw is the weight applied to a ladder at any point; F_{L} is the weight of the ladder itself; d is the distance of an external weight from the lower end of the ladder; θ is the positional angle defined by the relative orientation of the ladder length. The 0 at which the sum of Fy_EA+Fy or Fx_EA+FX2 are overcome by a shear force is the ladder slip angle.

The ladder slip angle is found by summing the forces acting at the vertical and horizontal contact points of the ladder. Summing the vertical forces acting on the ladder reveals:

Fy2=Fw+Fl−Fy−Fy_{—}EA (1)

It is known that:

Fy=μy*Fx (2)

and,

Fx2=μx*Fy2 (3)

Thus, summing up the moments around the horizontal substrate contact points produces

Fl*L/2*cos(θ)+Fw*d*cos(θ)−Fx*L*sin(θ)−Fy*L*cos(θ)−Fy_{—}EA*L*cos(θ)=0 (4)

Substituting equation 2 into equation 4 produces:

Fx=(Fl/2+Fw*d/L−Fy_{—}EA)/(tan(θ)+μy) (5)

A summation of the vertical forces yields:

Fx2=Fx−Fx_{—}EA (6)

Applying equation 6 to equation 3 produces:

Fy2=(Fx−Fx_{—}EA)/μx (7)

Now that most terms have been defined, equations 7 and 2 can be substituted into equation 1 to produce:

Fx(μy+1/μx)=Fw+Fl−Fy_{—}EA+Fx_{—}EA/μx (8)

Additionally, substituting equation 5 into equation 8 yields:

tan(θ)=((Fl/2+Fw*d/L−Fy_{—}EA)*(μy−1/μx))/(Fw+Fl−Fy_{—}EA+Fx_{—}EA/μx)−μy (9)

This represents the ladder slip angle at any given set of conditions such as weight of the person or equipment used with a ladder, the material of the ladder or contact points of a ladder, the material of the horizontal substrate, the material of the vertical substrate, the presence or absence of a electroadhesive device at either end of a ladder, and the electroadhesive resistive force created by each device.

At any given set of conditions, the ladder slip angle is only adjustable by creating a resistive force at either contact point of a ladder. This is because the coefficients of static friction of each surface as well as the weight of the ladder and the user and ladder length are all constants unchangeable by the system. By increasing the resistive forces of a device placed at either end of the ladder, the ladder slip angle can be radically reduced. A ladder is expected to remain stable and not slide along a substrate surface as long as the ladder positional angle is greater than the ladder slip angle.

In a field scenario, the realistic or practical angle range for positioning an extension ladder is 60-80 deg, while the optimal, standard-recommended angle is 75.5 deg. An alternative way to use the analytical model is by estimating the required coefficient of friction (RCOF) at the ladder base and demonstrating how it is changed by the electroadhesive forces available from an electroadhesive device. For a given ladder weight, given weight of a person at a distance up on the ladder, the RCOF can be plotted as a function of the ladder angle, by rearranging equation (9) to yield:

tan(θ)+μy=((Fl/2+Fw*d/L−Fy_{—}EA)*(μy+1/μx))/(Fw+Fl−Fy_{—}EA+Fx_{—}EA/μx) (10)

This can be written as:

C=A(μy+1/μx)/(B+Fx_{—}EA/μx) (11)

Where:

C=tan(θ)+μy (12)

A=Fl/2+Fw*d/L−Fy_{—}EA (13)

B=Fw+Fl−Fy_{—}EA (14)

Equation (11) can then be rearranged as:

μx=(A−C*Fx_{—}EA)/(CB−Aμy) (15)

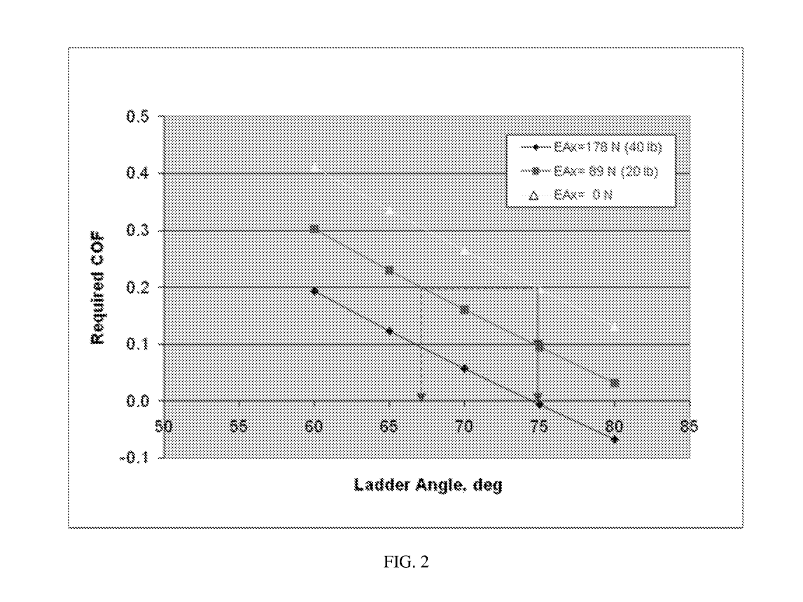

In equation (15) μx is the coefficient of friction required to keep the ladder from slipping for a given ladder positional angle, and weight of a person at a given distance up on the ladder. With a certain EA force, if the RCOF works out to a negative value, it implies the ladder is stable with only the electroadhesive force (even if mechanical friction disappears). FIG. 2 shows the variation of the RCOF with the ladder angle for various electroadhesive forces at the ladder base where the ladder is a 24 foot, 33.5 pound extension ladder. The assumed weight of the person in this case is 180 lbs, assumed COF against the wall is 0.4, and assumed position of the person on the ladder is at 0.8 L.

As seen from FIG. 2, when the ladder is set at the optimal standard-recommended positional angle (75.5 deg), an electroadhesive force of 20 lb reduces the RCOF by half, and an electroadhesive force of 40 lb completely eliminates the need for friction at the ladder base to keep the ladder in balance. Alternatively, an electroadhesive force of 20 lb at the ladder base allows the ladder setup angle to be lowered to 67 degrees for the same level of the RCOF; i.e., with the electroadhesive device engaged the ladder inclination may be set safely at a shallower positional angle without increasing the risk for the ladder sliding-out.

An inventive method includes attaching one or more electroadhesive devices to a contact point on a ladder. A contact point may be any position on a ladder capable of contact with a substrate. Typical contact points include a side rail top terminal end, a side rail bottom terminal end, a side surface such as the edge of a rung or a side rail, or a front or rear face of the ladder. A contact point is optionally adjacent to the location on a ladder contacting a substrate. An example of an adjacent point is the rung of a ladder which is near the terminal ends of the ladder actually contacting a substrate. A device is optionally attached to a ladder contact point through an intermediary structure such as a link, brace, extension, or other apparatus operable to fixedly or rotatably attach a device to any point on a ladder including a contact point. A rotatable connection is illustratively used so that the device can adhere to a substrate independent of ladder positional angle.

An electroadhesive device is a device operable to create electrostatic forces of adhesion between a device and a substrate. Illustrative examples of electroadhesive devices are described in: U.S. Patent Application Nos: 2008/0089002, 2010/0027187, 2010/0271746; and U.S. Pat. Nos. 7,773,363 and 7,551,419; the contents of each of which are incorporated herein in their entirety. At least one electroadhesive device is attached to a contact point of a ladder. It is appreciated that a plurality of electroadhesive devices are optionally attached to one or more contact points on a ladder. For example, an electroadhesive device is optionally attached to each of two terminal ends of a ladder such that one electroadhesive device is positioned to adhere to a vertical substrate such as a wall, and a second electroadhesive device is positioned to adhere to a horizontal substrate such as a floor.

Illustratively, a single electroadhesive device is attached to more than one contact point on a ladder. A first attachment point is illustratively a top end of a first side rail, and a second attachment point is a top end of a second side rail. A single electroadhesive device is optionally contacted to each top end of both side rails by one or a plurality of contact points.

An electroadhesive device is contacted to a substrate and an electrostatic force is applied to adhere the device to the substrate. A substrate as used herein is any surface operable for ladder attachment or to serve as a support for a ladder. Illustrative substrates include a wall such as an interior or exterior wall in finished or unfinished form; a corner of two or more walls; a roof; gutter; trim; siding; side of a boat, truck, or other vehicle; trees or other plant materials; a floor such as the floor of a house or vehicle; a driveway, roadway or other hard surface; or any other surface for which a ladder will contact during use. A substrate is made of any of a wide variety of materials or combinations of materials. A substrate material is illustratively concrete, wood, glass, plastic, ceramic, granite, rock, asphalt, or metal. Illustrative wall or floor materials include concrete, wood, steel, glass, and drywall. Illustrative floor materials include wood, ceramic, vinyl, concrete, or synthetic or natural rubbers. It is appreciated that the forgoing material lists are for illustrative purposes alone. One of ordinary skill in the art readily envisions other substrate materials suitable for contact with an electroadhesive device.

A substrate is optionally parallel to the vertical or horizontal direction as determined by the direction of the gravitational force. Illustrative examples include walls and floors. Alternatively, a substrate extends in any direction to the vertical or horizontal. Illustratively, a roof substrate is horizontal or angled to the horizontal. A substrate may be linear, curvilinear, irregular, or any shape. Illustratively, a substrate is a sculpture with undulating shape and size and which extends at multiple angles. A substrate is optionally the side of a home and has a regular patterned shape such as defined by traditional siding, shake siding, stucco, or any other exterior material. Optionally, a substrate is a corner such as the edge of a roof or a gutter.

A ladder is optionally positioned in a non-normal positional angle between a horizontal surface and a ladder length. A “non-normal positional angle” is any positional angle that is less than 90 degrees to the horizontal such as a horizontal surface. As defined herein, a horizontal surface is a surface that is perpendicular to the direction of gravity. Thus, any non-vertical ladder orientation will create a non-normal positional angle for the ladder.

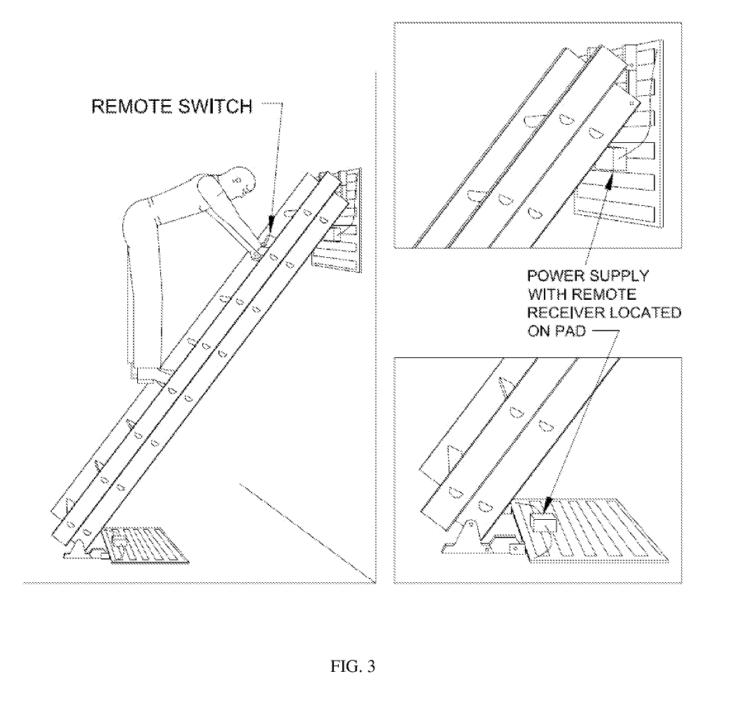

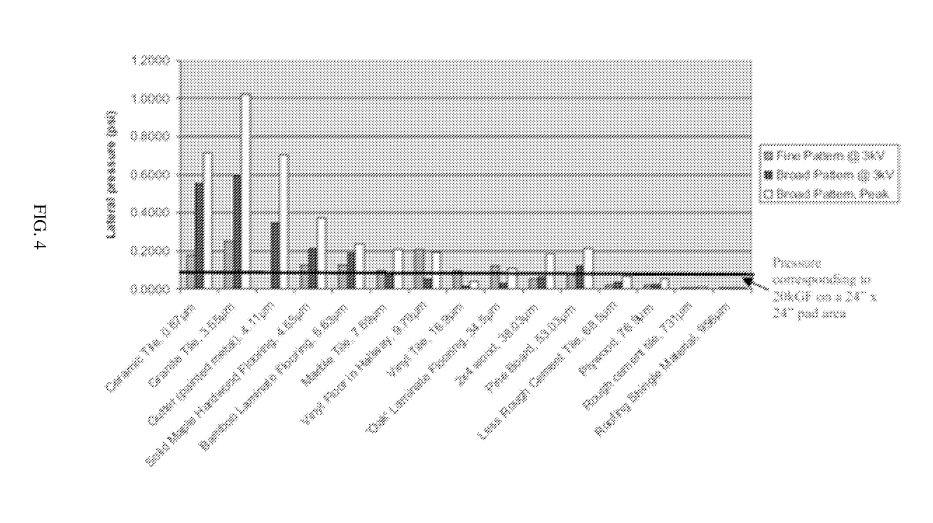

An electroadhesive device is contacted with a substrate such that the ladder forms a non-normal positional angle. The device is optionally contacted between a ladder contact point and a substrate, adjacent to a ladder contact point on the surface of a substrate, or a distance from a contact point on a substrate surface. Illustratively, an electroadhesive device is positioned on a wall substrate above or below the top of the ladder side rails. FIG. 3 illustrates a device contacting a wall substrate and a second device contacting a floor substrate. As seen in this embodiment, a device is optionally positioned between the top of the side rails and the wall and optionally extends below the attachment points. The second device is positioned adjacent to the lower end of the side rails with attachment points on one edge of the device. The lower end of the ladder side rails is also in contact with the floor substrate. It is appreciated that the devices are optionally positioned in any direction from the attachment points. Illustratively, the device may be positioned above, below, or to the side of the upper side rail attachment points. Similarly, the second device is optionally positioned in front, behind, or to the side of the lower side rail attachment points. Combinations of any of these positions are similarly operable.

A device optionally includes a power supply. A power supply is optionally a remote power supply such as that powered by a battery or plurality of batteries that may or may not be rechargeable, or powered by direct electrical connection to other power source such as an electrical energy grid typically supplying power to buildings. A power supply optionally includes a receiver. A receiver is optionally electrically connected to a switch that is available for a user to turn on and off the power to the device. A receiver may be remote from a switch so that a signal such as a radiofrequency signal or other signal known in the art allows communication between a switch and a receiver. In such a system a switch may be a remote switch that a user can position anywhere within signal communication with a receiver. This signal communication distance can be anywhere from a few centimeters to 100 meters or more. A user can place a ladder including a device in a location at a positional angle and activate the device at any time or from any location on the ladder. A remote switch provides a system whereby electrical connections are simplified by removing these connections from running along a length of the ladder between a switch and a device.

A device is optionally positioned to the side of a ladder side rail. In a non-limiting example, one or both of the upper ends of each side rail are attached to a device that extends between the side rails or to the side of the ladder. This positioning optionally provides horizontal stability to the top end of a ladder permitting a user to reach to the side of the ladder position with reduced risk of the ladder moving from side to side.

In some embodiments, a plurality of devices are attached to one or more attachment points on a ladder and are simultaneously in contact with one or more substrates. Illustratively, one of a plurality of devices is contacted with a vertical substrate, and one of the plurality of devices is contacted with a horizontal substrate. In some embodiments, a plurality of devices are attached to a single attachment point on a ladder, optionally positioned at non-zero angles relative to the other devices on the ladder or at the same attachment point. As such a plurality of devices optionally forms a shape that can be configured to attach to an irregular substrate such as the corner of two walls, a gutter, a sculpture, or other substrate surface. In this way the plurality of devices optionally conform to the shape of the substrate. It is appreciated that a device is optionally flexible such that a single device is capable of mimicking the shape of a substrate to which it is contacted.

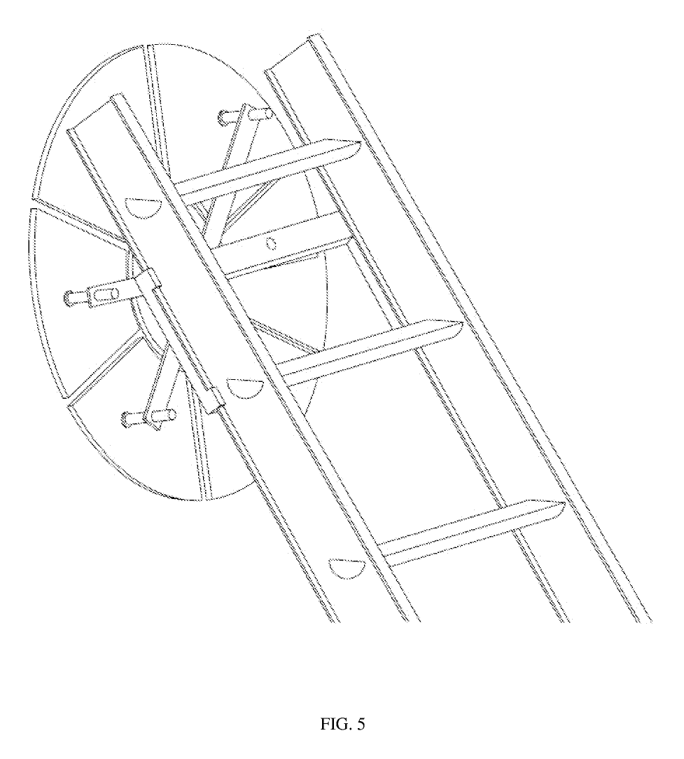

In some embodiments, a single device includes a plurality of adhesive surfaces. FIG. 5 illustrates one embodiment of a device with a plurality of adhesive surfaces or a plurality of devices attached to a single attachment point. Each of the adhesive surfaces or devices are positionally independent of the other adhesive surfaces or devices. Optionally, when a plurality of adhesive surfaces is employed each of the surfaces may include two electrodes with a voltage difference therebetween, thus, each acting as an independent adhesive device, but powered by fewer power sources than there are adhesive surfaces. Illustratively, a plurality of adhesive surfaces each include a single electrode that is electrically coupled to a single oppositely charged electrode to provide the electrostatic force required to form an adhesive attachment. When a plurality of adhesive forces are used, each may provide the required or desired adhesion force to provide ladder stability, or each may provide a portion of the required or desired adhesion force, the sum of which provides sufficient ladder stability. In some embodiments, the sum of the adhesion forces from each of the adhesive surfaces resists a shear force of 20 kg or more.

A device serves to decrease a ladder slip angle by providing an electroadhesive force between the device and the substrate. The electroadhesive force is an electrostatic adhesion voltage with a voltage level that produces a suitable electrostatic force for adhesion to a substrate. Electroadhesive devices are capable of producing a wide range of clamping pressures, which is the attractive force applied by the device toward the substrate divided by the area of the device in contact with the substrate. Clamping forces are described in terms of the normal clamping pressure (P_{N}) i.e. the electrostatic attraction pressure exerted normal to a substrate, the static friction coefficient (μ_{d}) between substrate and device, and the effective lateral adhesion pressure (P_{L}). The effective lateral adhesion pressure P_{L} represents the measured maximum lateral force without slippage divided by the surface area of the device without taking into account normal pressure exerted by the ladder itself. The three quantities are related by an equation similar to that of the force required to overcome static friction:

P_{L}=μ_{d}P_{N} (16)

Thus, by increasing the normal clamping pressure, the force required to move the device along the wall is increased.

The amount of shear force required to cause slippage at either point of a ladder is the sum of P_{L} and the static frictional force due to the ladder as readily calculated by:

Sy=P_{Ly}+μ*Fx (17)

Sx=P_{Lx}+μ*Fy2 (18)

One of ordinary skill in the art recognizes that when a device is positioned between the ladder contact point and the substrate that the shear force required is adjusted to P_{L} plus the coefficient of static friction of the device material with the substrate multiplied by the normal force.

It is appreciated that adhesion forces typically observed range from 0.7 kPa (about 0.1 psi) to 70 kPa (about 10 psi). Measured values using a device with an area of 4 ft² against typical wall or floor materials are illustrated in FIG. 4. It is appreciated that increasing the voltage between two electrodes associated with a device increases electrostatic forces. Also, decreasing the distance between the electrodes and substrate increases the electrostatic forces. Further, increasing the active contact surface area and device size increases electrostatic forces.

The electroadhesive force(s) applied by one or more devices attached to a ladder typically increase the shear force required to slide the contact point along a substrate. When one or more devices are used with a ladder the required shear forces are increased to between 1 and 50 kilograms. In some embodiments, the shear force required is in excess of 5 kilograms, optionally in excess of 20 kilograms. A required shear force in excess of 20 kilograms is appreciated to provide sufficient stability for an average sized adult male to use the ladder with minimal risk of ladder slippage. A shear force below 20 kilograms is optionally created by a device which provides additional stability at lower power consumption.

The application of a voltage to one or more devices is optionally sufficient to hold a ladder at a constant non-normal positional angle in excess of 15 degrees to the horizontal when the voltage difference is present. The constant positional angle in excess of 15 degrees is optionally held when a user of 45 kilograms or more is at any position on the ladder.

A method as provided herein optionally includes applying and releasing an electroadhesive force so that a ladder can be moved or otherwise repositioned. In some embodiments, the first voltage difference in a device is eliminated, a ladder is adjusted to create a different positional angle, and a second voltage difference is initiated in a device. The second voltage difference is optionally greater, equal to, or less than the first voltage difference. A user can thereby use a stable ladder, easily adjust ladder position, and then use a stable ladder in the new position.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### Example 1

A standard aluminum extension ladder with a length of 8 feet (collapsed) and a weight of 18 pounds is used to determine the function of one or two electroadhesive devices placed at the terminal ends of the collapsed ladder. For experimental conditions, the wall used is latex painted drywall at a nearly vertical direction and a floor is wood. The coefficients of static friction of the floor and wall are 0.55 and 0.42, respectively.

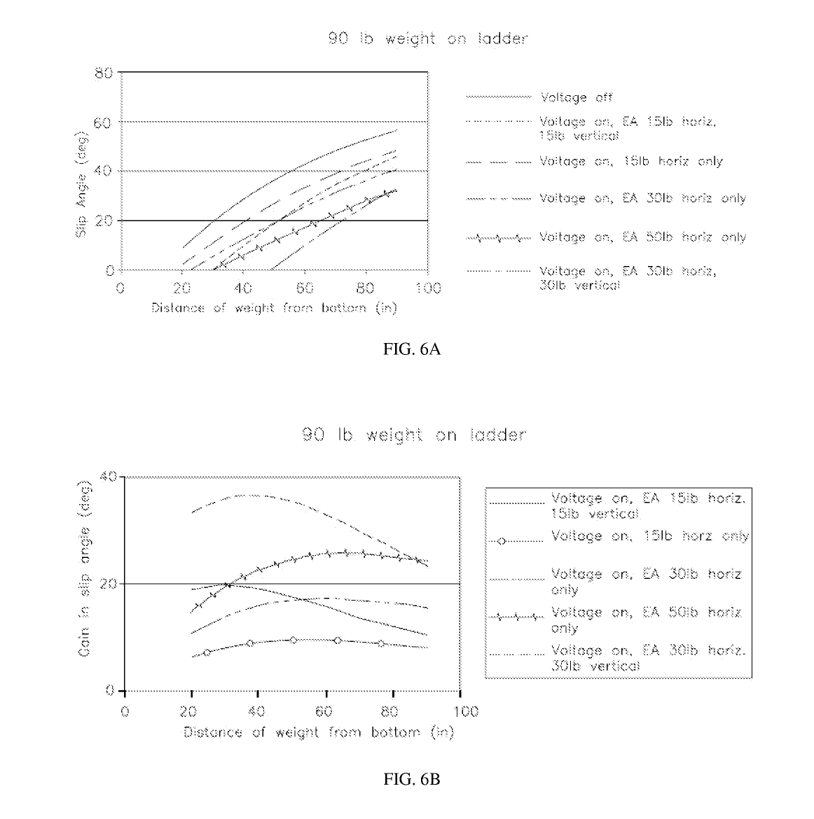

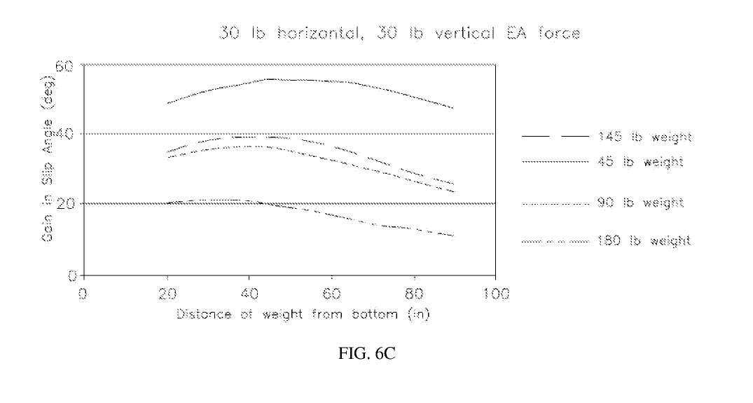

Using the above dimensions and static friction coefficients, the ladder and user parameters are introduced into equation 9 to calculate the ladder slip angles and gain in slip angle at moderate electroadhesive forces are plotted. FIG. 6A illustrates the calculated slip angle with a 90 pound weight suspended and an electrostatic attractive force (clamping force) of 15 or 30 pounds per device (30 pounds corresponding to 0.053 psi). FIG. 6B illustrates the gain in slip angle (i.e. decrease in slip angle) as a function of the weight from the bottom of the ladder. FIG. 6C illustrates the gain in slip angle using various weights ranging from 45 pounds to 180 pounds. These results indicate that the amount of gain in slip angle and amount of margin from slippage (at a given angle) is larger with more electrostatic force in place (i.e. higher voltage.) Also, even with moderate electrostatic forces of 30 pounds, a gain in slip angle of 20 to 40 degrees for a 90 pound weight, and of 10 to 22 degrees for a 180 pound weight can be achieved.

### Example 2

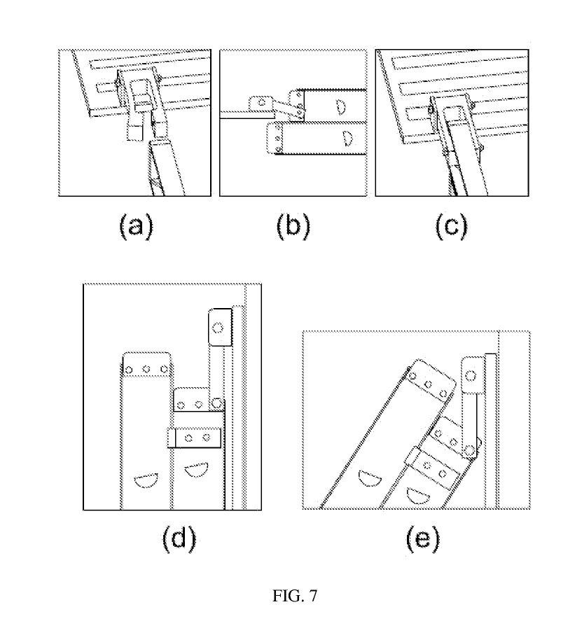

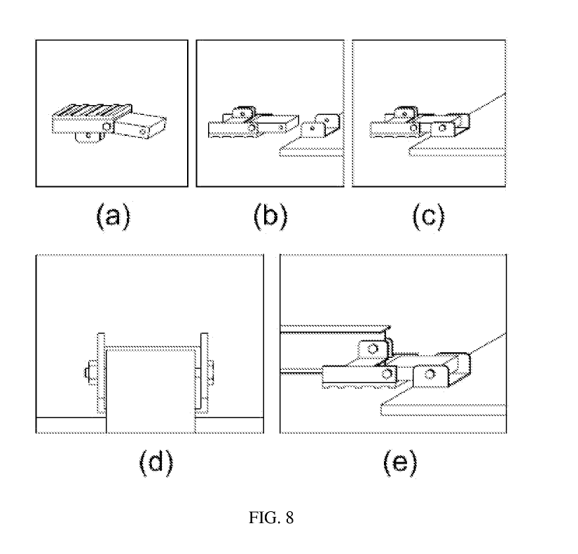

The ladder of Example 1 is used for experimental determination of slip angle with or without one or more electroadhesive devices applying electrostatic forces. An electroadhesive device is attached to the top end of each side rail (FIG. 7) and a second is attached to the bottom end of each side rail (FIG. 8).

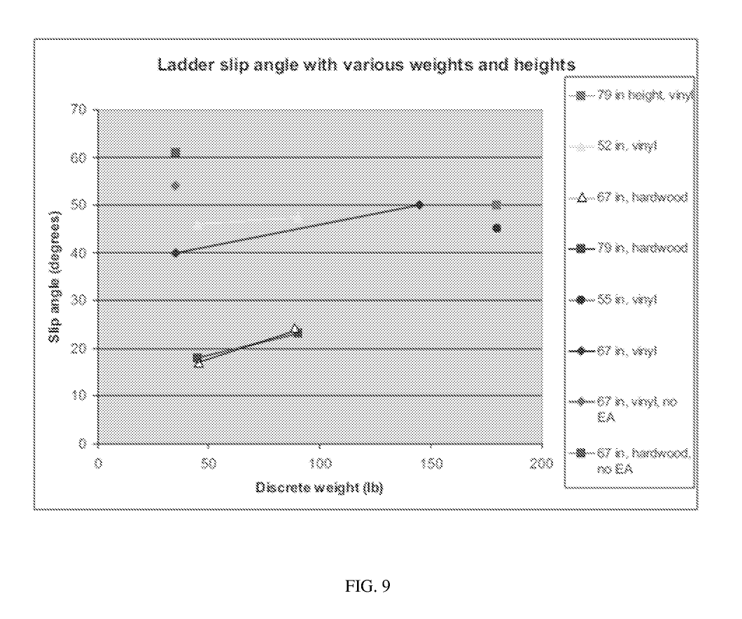

Two floor materials are tested, wood as an example of a high friction surface and vinyl as an example of a moderate friction surface. An electroadhesive force of 30 pounds is applied to each device. FIG. 9 illustrates the slip angles observed with discrete weights ranging from 45 pounds to 180 pounds added to the ladder at various positions along the length. For a 45 pound weight on a vinyl floor, the average slip angle decreases from 54 to 40 degrees with a single floor device engaged to an electroadhesive force of 30 pounds. The same conditions on a hardwood floor produce a reduction in slip angle from 62 degrees to 18 degrees indicating the improved efficacy on a substrate that provides for excellent electroadhesive clamping forces. Greater gains in slip angle are achieved with both a floor and a wall device activated simultaneously.

Various modifications of the present invention, in addition to those shown and described herein, will be apparent to those skilled in the art of the above description. Such modifications are also intended to fall within the scope of the appended claims.

Patents and publications mentioned in the specification are indicative of the levels of those skilled in the art to which the invention pertains. These patents and publications are incorporated herein by reference to the same extent as if each individual application or publication was specifically and individually incorporated herein by reference for the entirety of their teaching, that is each publication is incorporated herein by reference for the cited teaching as well as all other material contained therein.

The foregoing description is illustrative of particular embodiments of the invention, but is not meant to be a limitation upon the practice thereof. The following claims, including all equivalents thereof, are intended to define the scope of the invention.

We claim:

1. A method of decreasing a ladder slip angle comprising:
attaching at least one electroadhesive device to a contact point on a ladder;
contacting said device with a substrate such that the ladder forms a non-normal positional angle;
creating a first voltage difference between two electrodes within said device, wherein said voltage difference increases the shear force required to slide said contact point along said substrate thereby decreasing the ladder slip angle.

2. The method of claim 1 wherein said substrate surface is parallel to the vertical or horizontal direction.

3. The method of claim 1 wherein said substrate is curvilinear and said device conforms to said curvilinear surface.

4. The method of claim 1 wherein said shear force is between 1 and 50 kilograms.

5. The method of claim 1 wherein said shear force is in excess of 20 kilograms.

6. The method of claim 1 wherein a plurality of devices are each applied to a discrete contact point on said ladder.

7. The method of claim 6 wherein the shear force is increased to 5 kilograms or greater.

8. The method of claim 7 wherein said shear force is increased to at least 20 kilograms.

9. The method of claim 6 wherein at least one of said plurality of devices is contacted to a vertical substrate and at least one of said devices in contacted to a horizontal substrate.

10. The method of claim 1 wherein said device is comprised of a plurality of electroadhesive surfaces wherein each of said surfaces comprises two electrodes with a voltage difference therebetween.

11. The method of claim 10 wherein at least one of said electroadhesive surfaces is adhered to said substrate at a non-zero angle relative to at least one other adhesive surface.

12. The method of claim 10 wherein said plurality of electroadhesive surfaces conforms to the shape of said substrate.

13. The method of claim 1 wherein said device is comprised of a plurality of electroadhesive surfaces wherein each of said surfaces comprises one electrode with a voltage difference to a single opposing electrode common to all of said adhesive surfaces.

14. The method of claim 13 wherein the sum of the frictional forces from each of said adhesive surfaces resists a shear force of 20 kg or more.

15. The method of claim 1 wherein said non-normal angle remains constant while said voltage difference is present.

16. The method of claim 1 further comprising removing said first voltage difference;
altering said positional angle or moving said ladder; and
creating a second voltage difference between said two electrodes.

17. The method of claim 17 wherein said second voltage difference is greater or less than said first voltage difference.
